(19) United States
(12) Patent Application Publication
(10) Pub. No.: US 2002/0153028 A1
(43) Pub. Date: Oct. 24, 2002

(54) Metal halide lamp fabrication

(75) Inventors: Raghu Ramaiah, Euclid, OH (US); Bernard Bewlay, Schnectady, NY (US)

Correspondence Address: Timothy E Nauman, Fay Sharpe Fagan Minnich & McKee LLP, 1100 Superior Avenue 7th Floor, Cleveland, OH, 44114, US

(73) Assignee: General Electric Company

(21) Appl. No.: 09/782,632

(22) Filed: Feb. 13, 2001

(51) Int. Cl. B08B 7/00

(52) U.S. Cl. 134/19; 134/37; 134/25.4; 134/105

(57) ABSTRACT

The present invention concerns a process of treating an energizing electrode for use in a metal halide lamp. Lamp energizing electrodes are placed into a support container and the support container is then placed within an oven that bakes the electrodes at an elevated temperature. Hydrogen is caused to flow through the support container at a rate of from 5 to 60 liters per minute while the temperature is maintained within the oven between 2000 and 3200 degrees C. In accordance with an exemplary embodiment of the invention, the temperature is maintained within the oven at 2400 and 2600 degrees C., the dew point of the hydrogen is less than minus 40 degrees C. and the electrodes are baked for a period of 10 to 240 minutes. This process treats the electrodes in the support container and results in lamps having superior maintenance of lamp output as measured in lumens of output.

### FIELD OF THE INVENTION

The present invention concerns a metal halide lamp electrode fabrication process and apparatus that produces more consistent operation from lamps fabricated from electrodes using the process.

### BACKGROUND ART

High Intensity discharge (HID) lamps have been a mainstay of industrial and commercial lighting for decades due to their energy efficient light output. Typically applications of such lamps are in retail store lighting and offices. HID lamps have also been used in outdoor lighting such as in football and baseball stadiums where efficient sustained levels of high light output are required.

Chronologically, the first HID lamps were high pressure mercury lamps that were developed in about 1932. Around 1962 metal halide (MH) lamps where commercialized and in about 1965 high pressure sodium lamps were commercialized. Thirty years later, in the mid 1990's ceramic metal halide lamps (CMH) were commercialized.

In a conventional MH lamp, a fused silica (SiO₂), commonly known as quartz, vessel is fabricated having thoriated tungsten electrodes at each end that are sealed into the vessel in a hermetic manner. Since the vessel is made from quartz, these lamps are often referred to as quartz metal halide lamps (QMH). A charge of mercury, buffer gas (usually Argon), and a selection of metal halides is introduced into this vessel, and then the vessel is sealed off. During lamp operation, a plasma discharge is established by application of energy to the electrodes from outside the quartz vessel. The discharge quickly progresses from a glow discharge (low power) to an arc-discharge (high power).

The charge of metal halides that is added to the QMH lamp is what determines its operating characteristics. This charge is chosen from chlorides, bromides and iodides of a wide range of metallic elements, from sodium to the rare-earths. Evaporated halides dissociate in the high temperatures of the arc, liberating neutral metal atoms and the corresponding halogen atoms. In the arc, the metal atoms are excited to higher energy states by collisions with electrons in the plasma, and upon de-excitation, a significant part of the released energy is in the visible region of the electromagnetic spectrum (400-700 nm.). It is a selective release of energy in the visible region that makes HID lamps so energy efficient, when compared to an incandescent lamp, which theorectically releases energy in all wavelengths.

The discharge vessel of a QMH lamp cannot operate safely at temperatures over 950 degrees C. Temperatures above this cutoff produce irreversible changes in the structure of the vessel due to crystallization of the silica. Experience with QMH lamps show that during operation the fused silica of the vessel that maintains the arc absorbs sodium (Na) from inside the arc chamber. This steady depletion of sodium over time causes a color shift of the lamp, due to an imbalance created between the sodium atoms and other species inside the arc chamber.

The operation of Ceramic Metal Halide (CMH) lamps is similar to the operation of the QMH lamps discussed above. In the CMH lamp, however, the arc-tube material is made of Poly Crystalline Alumina (PCA). This material allows for significantly higher operating temperatures without damage to the vessel. The PCA material also allows for greater dimensional control of the arc tube fabrication and results in low diffusivity of sodium from the sodium iodide (NaI) pool inside the arc chamber into the PCA vessel material. Advantages from these features of QMH lamps are discussed in a paper entitled “Ceramic Metal Halide Lamps: Approach to the Light Source of the Decade” by co-inventor Raghu Ramaiah, which is incorporated herein by reference.

Lamp manufacturers have published ratings of their lamps which include the power required to operate the lamp as well as the performance of the lamp over time. One characteristic of lamp operation is the light output in lumens. A lumen is defined as the amount of light a source of one candlepower emits in a one unit solid angle. Thus, for a given power consumption, the higher output in lumens a lamp produces, the more efficient that lamp is converting its input power to light. It is a fact that the light output from HID lamps degrades with time. For this reason, lamp manufacturers not only publish the lumen output at a time near the beginning of a lamp's useful life but also publish data concerning expected lamp performance after a certain amount of time. Industry standard data is published for example in lumens after 100 hours of operation and to show useful lifetime the expected output in lumens is also published for lamps that have experienced (typically) 8000 hours of operation.

FIGS. 1 is a depiction of a prior art metal halide arc tube 10 having two main electrodes 12, 14 for energizing the lamp by setting up a arc-discharge within an interior 16 of the arc tube. FIG. 1A is an enlarged depiction of one of the electrodes. The electrode 12 includes a main wire shank portion 20 and a coil section 22 formed by wrapping a second wire around the main shank portion 22. The material of the shank section is 2% Thoriated tungsten and the coil section wire is K-doped tungsten. In accordance with a prior art treating process used to prepare the electrodes such as the one shown in FIG. 1A, the electrodes are subjected to a bake at about 1500 degrees C. for approximately 15 minutes. The electrodes process in accordance with this bake are then incorporated into metal halide lamps by fabricating techniques known in the art.

### SUMMARY OF THE INVENTION

The present invention concerns a process of treating an electrode prior to use in a metal halide lamp. The invention is performed by placing one or more energizing electrodes into one or more support containers or crucibles and positioning the support container within an oven that bakes the one or more electrodes within the container at an elevated temperature. Hydrogen is caused to flow through the support container at a rate of from 5 to 60 liters per minute while the temperature is maintained within the oven between 2000 and 3200 degrees C. More particularly, in one exemplary embodiment of the present invention the oven is maintained at a temperature of between 2400 and 2600 degrees C. This process cleans the electrodes in the support container.

In accordance with an exemplary embodiment of the invention the dew point of the hydrogen is less than minus 40 degrees C. and the electrodes are baked for a period of 10 to 240 minutes.

The exemplary processing results in electrodes, which when incorporated into metal halide lamps provide increased maintained lumen output and reduced variability in maintained lumen output. These and other objects, advantages and features of the invention will become better understood from a detailed description of an exemplary embodiment of the invention which is described in conjunction with the accompanying drawings.

### BRIEF DESCRIPTION OF THE DRAWINGS

FIG. 1 is a depiction of a prior art metal halide arc tube that forms a part of a metal halide lamp;

FIG. 1A is a depiction of a prior art electrode used in fabricating a metal halide arc tube;

FIG. 2 is a partially sectioned plan view of an oven for use in treating electrodes;

FIG. 3 is a depiction of a support crucible for supporting electrodes within the oven shown in FIG. 2;

FIGS. 4A and 4B are images from an electron microscope at 5,000 and 10,000 magnification showing an electrode surface produced using a prior art baking process;

FIGS. 5A and 5B are Auger maps of Thorium and Oxygen showing inclusions in the electrodes produced using a prior art baking process;

FIGS. 6A and 6B are images from an electron microscope at 5,000 and 9,000 magnification showing an electrode surface produced using a baking process practiced in accordance with the present invention;

FIGS. 7A and 7B are Auger maps of Thorium and Oxygen showing inclusions in the electrodes produced using a baking process practiced in accordance with the present invention;

FIG. 8 is a graph comparing 2000 hour average lumens output from lamps having electrodes baked by a prior art process with electrodes baked in accordance with the present invention; and

FIG. 9 is a graph comparing standard deviation of 2000 hour % lumens from lamps having electrodes baked by a prior art process with electrodes baked in accordance with the present invention.

### EXEMPLARY MODE OF PRACTICING THE INVENTION

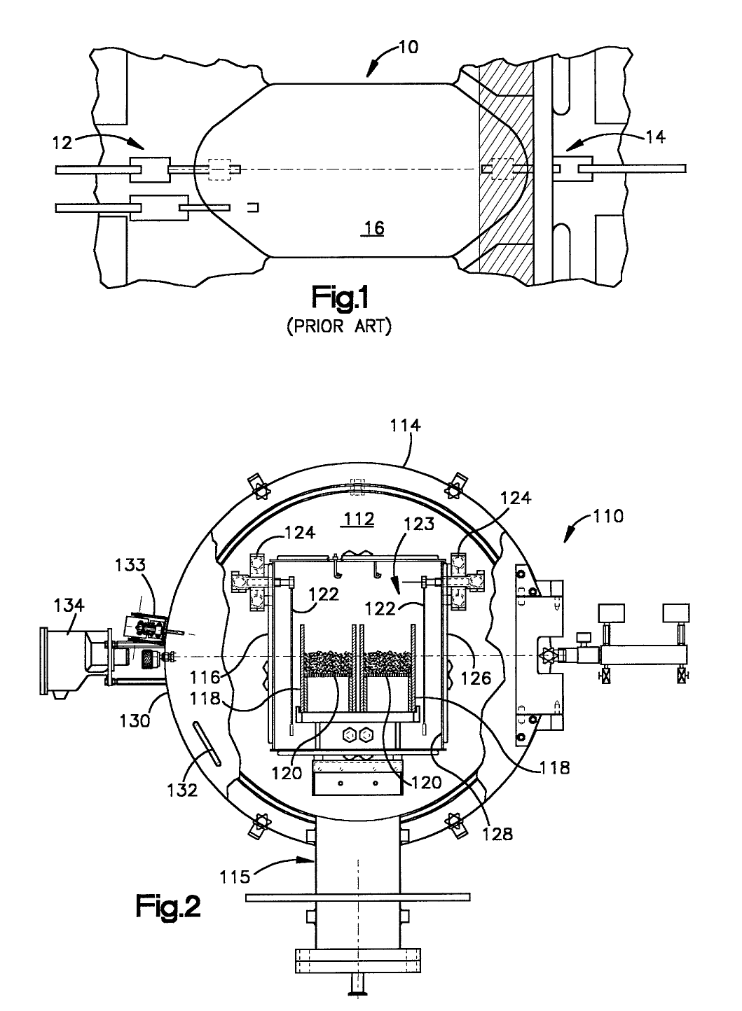

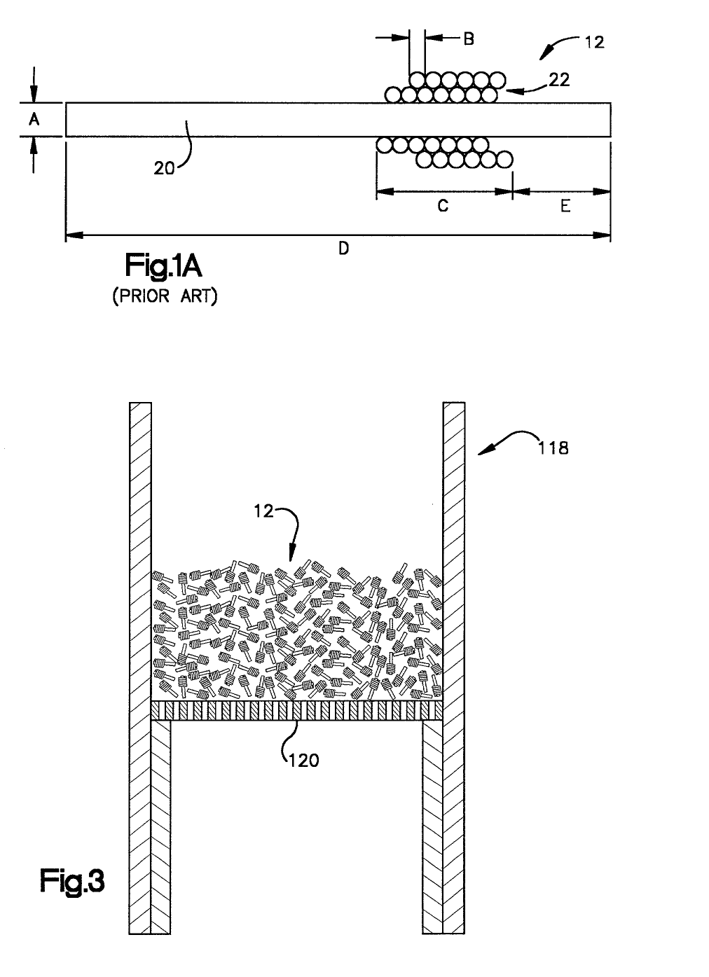

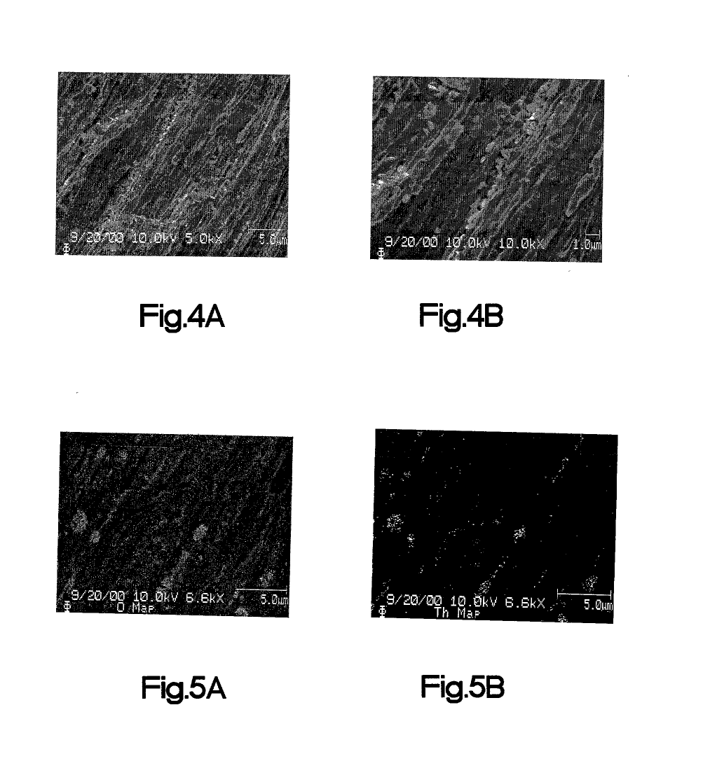

FIG. 2 depicts a vacuum chamber and oven assembly 110 that defines an interior region 112 for treating electrodes 12 such as electrodes like the one depicted in FIG. 1A prior to their use in fabricating HID lamps. The vacuum chamber and oven assembly 110 includes a vacuum chamber 114 and a resistance furnace or oven 116 disposed within the vacuum chamber 114.

Prior to heating the electrodes 12, the vacuum chamber interior region 112 is evacuated by a vacuum pump (not shown) through an exit pipe 115 extending through the vacuum chamber wall. A pair of heating elements 122 are disposed within an interior region 123 of the oven 116. The heating elements 122 are energized to heat the oven 116 to a desired temperature by respective internal power feed through assemblies 124 which extend through a heater jacket 126 and heat shields 128 comprising the oven wall. One side of the vacuum chamber 114 includes a hinged door 130 with a door handle 132 to allow access to the oven 116 and specifically the oven interior region 123. The vacuum chamber door 130 is position is maintained in an closed position by a pneumatic clamp assembly 133. Affixed to the vacuum chamber door 130 is a two color pyrometer 134 for monitoring temperature in the oven 116.

The lamp energizing electrodes 12 treated in the oven 116 are supported within a pair of support containers or crucibles 118 supported within the oven. The exemplary process is performed by placing the electrodes 12 into the two crucibles 114 and then positioning the crucibles 114 within the oven 116 and treating the electrodes within the crucibles 114 at an elevated temperature. The crucibles 118 each include a porous bottom surface 120 to allow a gas such as hydrogen to flow over the electrodes 12 disposed in the respective crucibles 118 during the heating process.

Hydrogen is caused to flow through the support containers 118 at a rate of from 5 to 60 liters per minute while the temperature within the oven is maintained between 2000 and 3200 degrees C. This process cleans the electrodes in the crucible. In one exemplary preferred embodiment of the present invention, the temperature within the oven is in a range of 2400 to 2600 degrees C.

Following treatment in the oven 110 the electrodes that have been treated are processed by known prior art techniques and are incorporated into metal halide lamps. The baking of the electrodes significantly improves the lamp performance when compared with lamps manufactured using prior art electrode cleaning procedures.

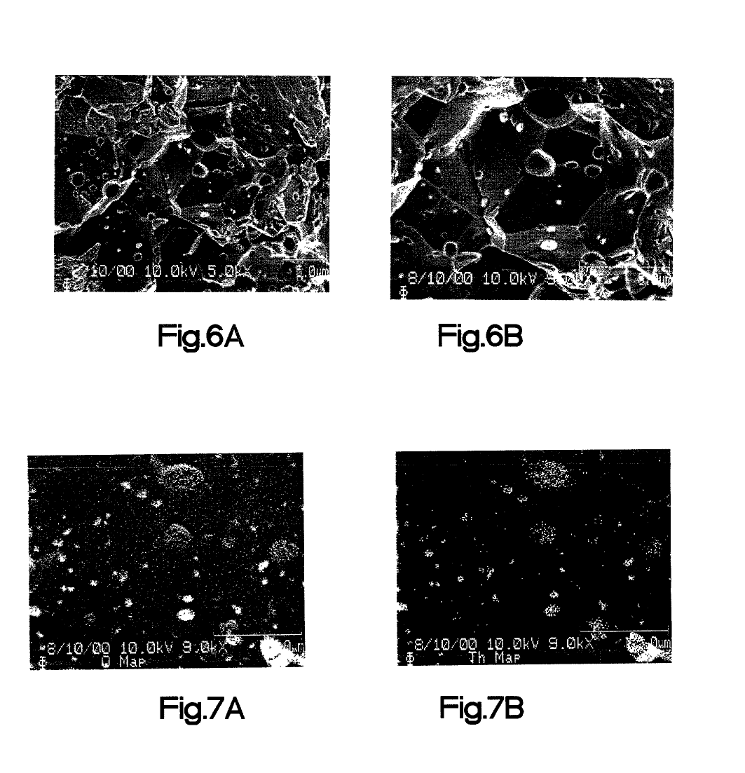

Electrodes treated in accordance with the invention can be clearly distinguished from electrodes that have undergone prior art treating prior to use in a lamp. FIGS. 5A and 5B are two examples of an analysis done on an electrode treated in accordance with the prior art. FIG. 5A shows magnification of 5000 and FIG. 5B shows magnification of 10,000. It is seen that the fibrous structure of the tungsten is maintained by this treatment and the crystal structure is not evident at 10,000 magnification. Particles of finely dispersed Thorium Oxide (ThO₂) can be seen in both FIGS. 5A and 5B as lighter colored inclusions in the matrix of tungsten. FIGS. 6A and 6B depict Auger maps of the samples shown in FIGS. 5A and 5B showing Thorium and Oxygen, to further confirm that the occlusions are ThO₂.

FIGS. 6A and 6B are electron microscope images (5,000 and 9,000 magnification respectively) depicting the structure of the Tungsten matrix of electrodes treated in accordance with the present invention. Large well defined grains of tungsten are seen, even at 9,000 magnification. The dispersion of ThO₂ is seen and the corresponding Thorium and O₂ Auger maps are shown in FIGS. 7A and 7B for electrodes treated in accordance with the invention.

Several tests using metal halide lamps having electrodes treated with the new process and the prior art treatment process were performed and results compared. In every test it was determined that there is a statistical, significant improvement in average lumen output and there is a statistical, significant reduction in lumen variability.

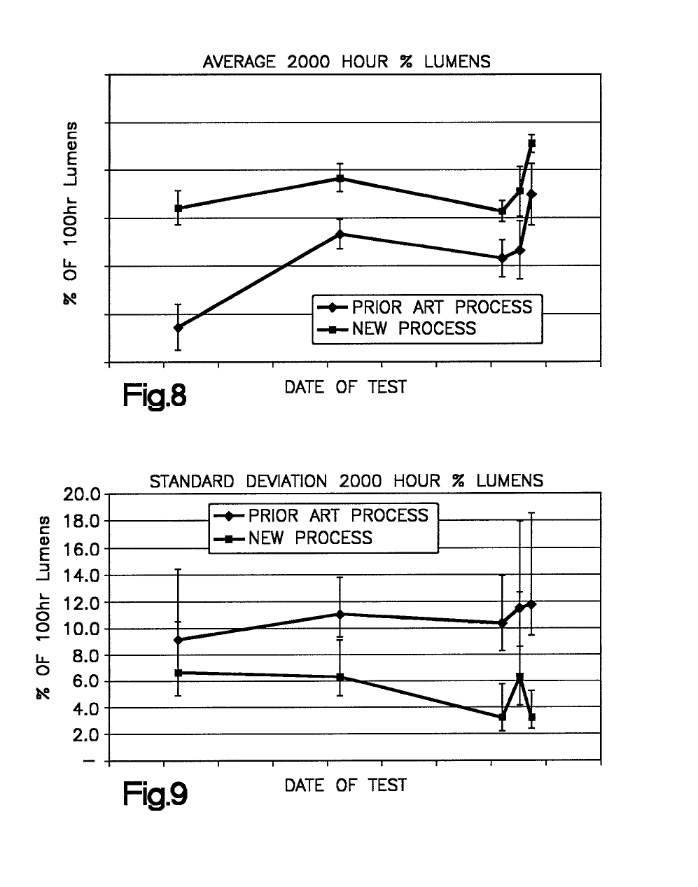

FIG. 8 is a graph showing test data from five tests run over a several month time period. The data indicate the average performance of the lamps with electrodes treated in accordance with the invention is always higher than lamps that use electrodes from the prior art treatment process. The performance metric used in the lamp industry is a parameter called “%lumens”, which is obtained by dividing the lumens measured at a given time interval by the lamp output measured in lumens after 100 hours of lamp operation (with a scale factor), where all such measurements are performed by operating the lamp at its rated power.

TABLE 1
2000 hours Lumens

| | Prior Art Process | New Process | t-Test |
|---|---|---|---|
| | Sample Size | Sample Size | Probability p |
| Test#1 | 15 | 15 | 0.000 |
| Test#2 | 48 | 20 | 0.000 |
| Test#3 | 29 | 10 | 0.000 |
| Test#4 | 16 | 8 | 0.001 |
| Test#5 | 15 | 14 | 0.003 |

Table 1 set forth the results of T-tests done on the measured lumens at 2000 hours utilizing the test data illustrated in FIG. 8. It is clear from the test date and the associated t-Test probabilities that the difference between the prior art process and the treatment process of the present invention is statistically significant, at the 95% confidence level. These tests substantiate improved average lumen performance through practice of the present invention.

FIG. 9 is a plot of the standard deviations of %lumens for the test data used to generate FIG. 8. Also shown in FIG. 9 are the 95% confidence intervals. Carefully examining FIG. 9, one can determine that the standard deviations of lamps treated in accordance with the present invention is reduced, when compared with similar data for lamps treated by the prior art process. Table 2 (set forth below) analyzes-the standard deviations of the test data shown in FIG. 9 using an F-test. The results of the statistical analysis show that in virtually all cases, the variability in the lumens at 2000 hours of electrodes treated with the process of the present invention is significantly smaller than the variability obtained using electrodes treated with the prior art process. These results indicate that the variability in maintained lumens is significantly reduced by using electrodes treated in accordance with the present invention.

TABLE 2
2000 hour standard deviation

| | Prior art Process | New Process | F Test |
|---|---|---|---|
| | Sample Size | Sample Size | Probability p |
| Test#1 | 15 | 15 | 0.144 |
| Test#2 | 48 | 20 | 0.004 |
| Test#3 | 29 | 10 | 0.000 |
| Test#4 | 16 | 8 | 0.049 |
| Test#5 | 15 | 14 | 0.000 |

The present invention has particular application for using in making metal halide lamps having increased maintained lumen output and reduced variability in maintained lumen output. While the present invention has been described with a degree of particularity, it is the intent that the invention include all modifications and alterations from the disclosed embodiments falling within the spirit or scope of the appended claims.

1. A process of treating an energizing electrode for use in a metal halide lamp comprising:
a) placing one or more energizing electrodes into a support container and positioning the support container within an oven for subjecting the one or more electrodes within the container to treatment at an elevated temperature; and
b) flowing hydrogen through the support container at a rate of from 5 to 60 liters per minute while maintaining the temperature within the oven between 2000 and 3200 degrees C. to clean the electrodes in the support container.

2. The process of claim 1 wherein the temperature within the oven is maintained between 2400 and 2600 degrees C.

3. The process of claim 1 wherein the dew point of the hydrogen is less than minus 40 degrees C.

4. The process of claim 1 wherein the electrodes are baked for a period of 10 to 240 minutes.

5. The process of claim 1 wherein the dew point of the hydrogen is less than minus 40 degrees C. and the electrodes are baked for a period of 10 to 240 minutes.

6. The process of claim 5 wherein the electrodes are baked for a time of about 30 minutes in flowing hydrogen of about 30 liters per minute having a dew point of about minus 65 degrees C. at a temperature of about 2800 degrees C.

7. Apparatus for treating energizing electrodes for use in a metal halide lamp comprising:
a) a support container for supporting a plurality of electrodes within the container during treatment of those electrodes within the support container;
b) an oven for treating the electrodes within the support container for a controlled time period at a specified temperature;
c) a supply of hydrogen for routing hydrogen through the support container inside the oven at a rate of from 5 to 60 liters per minute; and
d) a controller for maintaining the temperature within the oven between 2000 and 3200 degrees C. to clean the electrodes in the support container.

8. The apparatus of claim 7 wherein the controller maintains the temperature within the oven between 2400 and 2600 degrees C.

9. A process of treating an energizing electrode for use in a metal halide lamp comprising:
a) placing one or more energizing electrodes into a support container and positioning the support container within an oven for subjecting the one or more electrodes within the container to treatment at an elevated temperature; and
b) flowing hydrogen through the support container at a rate of from 5 to 60 liters per minute while maintaining the temperature within the oven between 2400 and 2600 degrees C. to clean the electrodes in the support container.

10. The process of claim 9 wherein the dew point of the hydrogen is less than minus 40 degrees C.

11. The process of claim 9 wherein the electrodes are baked for a period of 10 to 240 minutes.

12. The process of claim 9 wherein the dew point of the hydrogen is less than minus 40 degrees C. and the electrodes are baked for a period of 10 to 240 minutes.

13. The process of claim 11 wherein the electrodes are baked for a time of about 30 minutes in flowing hydrogen of about 30 liters per minute having a dew point of about minus 65 degrees C. at a temperature of about 2800 degrees C.
